(19) United States
(12) Patent Application Publication
(10) Pub. No.: US 2007/0201027 A1
(43) Pub. Date: Aug. 30, 2007

(54) Innovative Raster-Mirror Optical Detection System For Bistatic Lidar

(76) Inventors: Valentina V. Doushkina, Aliso Viejo, CA (US); Anatoliy I. Khizhnyak, Irvine, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/672,418

(22) Filed: Feb. 7, 2007

Related U.S. Application Data
(60) Provisional application No. 60/771,547, filed on Feb. 7, 2006.

(51) Int. Cl. G01N 21/00

(52) U.S. Cl. 356/338

(57) ABSTRACT

According to an exemplary embodiment of the present invention, an optical measurement apparatus includes a raster-mirror, an objective element, and a detector element. The raster-mirror includes a plurality of mirror segments that are articulated relative to adjacent mirror segments and configured to receive light from a portion of a field of view and provide a reflected light portion, where the plurality of reflected light portions comprise a reflected beam. The objective element is configured to receive the reflected beam and provide an objective beam having a plurality of objective beam portions corresponding to the plurality of reflected light portions. The detector element includes a plurality of detector portions and is configured to receive the objective beam and provide a corresponding image signal, where the plurality of objective beam portions are simultaneously imaged on the plurality of different detector portions.

### RELATED PATENT APPLICATION

This application claims priority to a provisional patent application, Ser. No. 60/771547, filed on Feb. 7, 2006, in the United States Patent Office, the entire content of the provisional application is hereby incorporated by reference.

### STATEMENT REGARDING FEDERALLY SPONSORED RESEARCH

This invention was made with government support under Contract Number DG133R04CN0118 awarded by the U.S. Department of Commerce/NOAA under an SBIR contract to MetroLaser, Inc. The government has certain rights in the invention.

### TECHNICAL FIELD

The present invention is related to optical measurement techniques, and more particularly to measuring atmospheric properties based on light scattering.

### BACKGROUND

For decades, ground-, air-, and satellite-based optical remote sensing instruments have provided the means by which aeronomers have studied the complex processes that take place in the atmosphere. Optical remote sensing techniques have been widely used for continuous monitoring of boundary layer aerosols to assess the impact of anthropogenic and natural aerosols on climate and to monitor spatial and temporal atmospheric aerosol profiles, which are essential for air quality and health related studies. Aerosols play a strong role in the Earth's radiation budget and, thus, in global climate change. Since aerosol types, chemistry, concentrations, and effects on radiation budgets are highly variable and strongly altitude-dependent, measurements of aerosol properties as a function of altitude are especially important for understanding physical, chemical, radiative properties, and dynamics of the atmosphere.

Traditional monostatic lidar (LIght Detection And Ranging) systems where the laser transmitter and receiver are located in the same place, have been broadly used. However, they are not effective for measurements in a low atmosphere and especially in the near range, because the field of view near the ground may become obstructed and they are limited by uncertainties introduced in an overlap function that corrects for discrepancies between transmitter divergence and receiver field of view at ranges that are close to the measurement instrument. Early bistatic lidar systems, where the receiver and the transmitter are not located in the same place, allowed the highest range resolution near the ground and gradually decreasing at higher altitudes. These early bistatic lidar systems could measure scattering from aerosols, fog and clouds up to about 300 meters above the ground. Therefore, there remains a need in the art to provide an improved range resolution, increased altitude range, and improved signal-to-noise (S/N) ratio in measuring atmospheric properties based on light scattering.

### SUMMARY

An innovative, bistatic Clidar, a charge-coupled device (CCD) based LIght Detection And Ranging (LIDAR) receiver, to measure aerosol scattering in the atmospheric boundary layer has been developed and tested. The inventors have developed an innovative optical system design for bistatic Clidar. The tested design is based on dividing the vertical field of view into a plurality of sectors, using a 1-D non-moving raster mirror for each sector and parallel imaging of laser light scattered from each sector onto one CCD-matrix, and utilizing a single objective with a narrow angle of view. By employing a parabolic or elliptical mirror as an objective, chromatic aberration can be eliminated. Hence, one or more embodiments can be used in a broad spectral range including infrared (IR) to ultraviolet (UV).

The novel receiver having concave or convex raster-mirror designs may provide greater than two-orders of magnitude light gathering capability improvement, while also providing higher altitude resolution than previous designs. In this manner, this novel approach enables the use of lower power, eye safe lasers, which were previously not useful in this type of application. One or more embodiments provide for dividing a wide (greater than 100°) vertical field of view into a plurality of sectors, using 1-D rastering of mirrors and parallel imaging of the laser light scattered from each sector onto different portions of one CCD while employing a single narrow angle-of-view objective. In this manner, the raster-mirror (input aperture) is split in a first dimension into a plurality of sub-mirrors to image the scattered laser light from the field of view. The system is applicable for separate and simultaneous measurements of scattered light from several laser beams to obtain spectral, spatial, and temporal information about the aerosols in the atmosphere. Using an off-axis parabolic mirror objective eliminates chromatic aberrations, making the system employable in a broad spectral range from UV to IR. The advantages further include providing greater control of the dynamic range of the registered signal, providing a superior height resolution of about 20 mm/pixel at the ground level, providing an improved height resolution of about 3 m/pixel at 20 km altitude, at a lower cost, and utilizing lower-power and/or eye-safe lasers to comply with air traffic regulations. The novel bistatic CLidar receiver may include automatic system feedback and self-calibration, and the system may accommodate daytime operational conditions.

In particular, according to an exemplary embodiment of the present invention, an optical measurement apparatus includes a raster-mirror, an objective element, and a detector element. The raster-mirror includes a plurality of mirror segments that are articulated relative to adjacent mirror segments and configured to receive light from a portion of a field of view and provide a reflected light portion, where the plurality of reflected light portions comprise a reflected beam. The objective element is configured to receive the reflected beam and provide an objective beam having a plurality of objective beam portions corresponding to the plurality of reflected light portions. The detector element includes a plurality of detector portions and is configured to receive the objective beam and provide a corresponding image signal, where the plurality of objective beam portions are simultaneously imaged on the plurality of different detector portions.

According to another exemplary embodiment of the present invention, an optical detection method includes receiving light scattered from atmospheric aerosols, reflecting the received scattered laser light using a raster-mirror having a plurality of mirror segments where each mirror segment is articulated relative to an adjacent mirror segment and configured to receive light from a portion of a field of view and provide a reflected light portion, imaging the plurality of reflected light portions simultaneously on different portions of a detector element to provide an image signal, and measuring at least one of a spectral, a spatial, and a temporal property about the atmospheric aerosols based on the plurality of image signals.

The scope of the present invention is defined by the claims, which are incorporated into this section by reference. A more complete understanding of embodiments of the present invention will be afforded to those skilled in the art, as well as a realization of additional advantages thereof, by a consideration of the following detailed description. Reference will be made to the appended sheets of drawings that will first be described briefly.

### BRIEF DESCRIPTION OF THE FIGURES

FIG. 1 illustrates a perspective view of an exemplary embodiment of a Bistatic Clidar system, in accordance with an embodiment of the present invention.

FIG. 2 illustrates a plan view of an exemplary detector element, in accordance with an embodiment of the present invention.

FIG. 3A illustrates a perspective view of a single-channel Clidar receiver having a concave raster mirror and a refractive objective, in accordance with an embodiment of the present invention.

FIG. 3B illustrates a perspective view of another single-channel Clidar receiver having a concave raster mirror and a refractive objective, in accordance with an embodiment of the present invention.

FIG. 4 is a graph illustrating the analytical performance of a particular Clidar receiver, in accordance with an embodiment of the present invention.

FIG. 5 illustrates a perspective view of a dual-channel Clidar receiver having a concave raster-mirror and a refractive objective, in accordance with an embodiment of the present invention.

FIG. 6 illustrates a perspective view of a single-channel Clidar receiver having a convex raster-mirror and a reflective objective, in accordance with an embodiment of the present invention.

FIG. 7 illustrates a perspective view of an exemplary concave raster-mirror, in accordance with an embodiment of the present invention.

Embodiments of the present invention and their advantages are best understood by referring to the detailed description that follows. It should be appreciated that like reference numerals are used to identify like elements illustrated in one or more of the figures.

### DETAILED DESCRIPTION

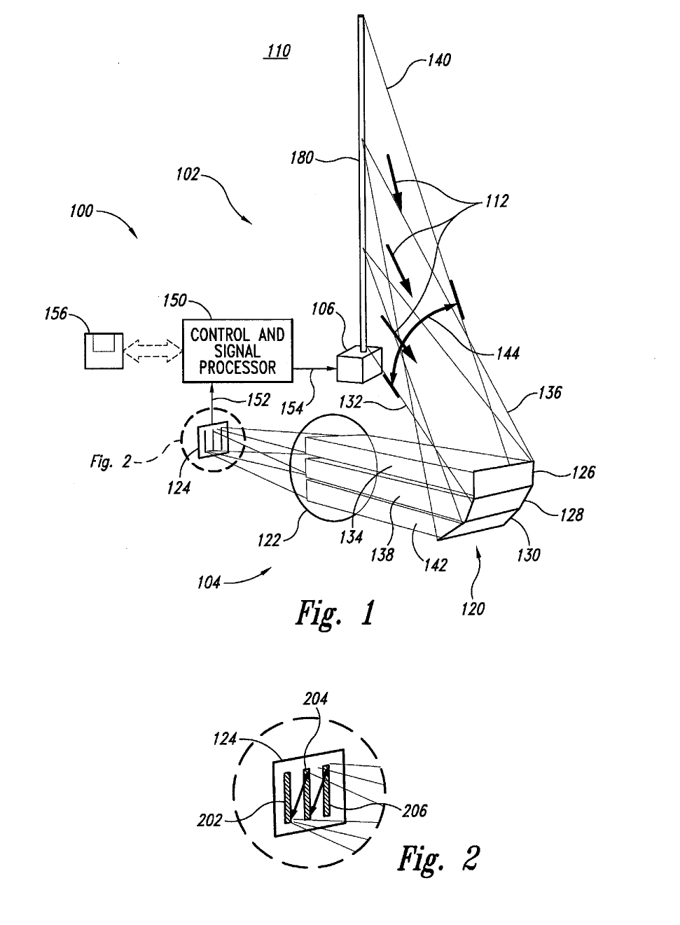

FIG. 1 illustrates a perspective view of an exemplary Bistatic Clidar system 100, according to an embodiment of the present invention. Bistatic Clidar system 100 may include a laser transmitter 102 and a Clidar receiver 104, where transmitter 102 and receiver 104 are not located in the same place. In general, receiver 104 is based on dividing a vertically oriented field of view into a plurality of sectors using a non-moving raster-mirror, where the plurality of sectors are rasterized by a plurality of articulated flat mirror segments. Alternatively, receiver 104 may be oriented differently for a particular application measuring other than a vertical field of view.

In at least one embodiment, the planes of the articulated mirror segments or sections are tilted with respect to each so that the reflected image of a particular region of the vertical field of view (FOV) is not projected on top of another projected region, to provide high resolution detection and/or to permit a better use of the detector elements. In the prior instruments, the entire beam was imaged into one line on the detector, whereas embodiments of the present invention provide up to an N-times improvement, where N is the number of sub-mirrors that image light onto different regions of the detector. In this manner, the entire area of the detector may be utilized to provide superior spatial resolution. Alternatively, one or more of the reflected images may at least partially overlap a region of the detector array. Overlap of adjacent segments may allow a continuous altitude profile to be measured, and may provide a level of redundancy both to provide confirmation measurements of the same space, or to provide additional capability for when a portion of the detector is not functioning. In another alternative, a particular mirror may reflect a portion of the field of view that is reflected by another mirror.

Transmitter 102 may include a laser emitter 106 configured to emit a laser beam 108 into an atmosphere 110 or region, and aerosols within atmosphere 110 may scatter light from beam 108 to provide scattered light radiation or a beam 112. Emitter 106 may be a pulsed Nd:YAG laser having a frequency of about 20 Hz. Alternatively, a continuous beam laser may also be used where the captured signal is properly conditioned.

Receiver 104 may include a concave raster mirror 120, a refractive objective element 122, and a detector element 124. Mirror 120 is considered convex since the reflective portion of mirror 120 is curved inward as shown, like the inner surface of a sphere. A portion of the scattered light 112 from transmitter 102 is incident upon raster mirror 120 that includes a plurality of reflective mirror segments (126, 128, and 130). The mirror segments are preferably planar (flat), but they may be non-planar having a convex or concave shape. As shown in FIG. 1, a first scattered light sector 132 may be reflected by a first mirror segment 126 to provide a first reflected beam 134, a second scattered light sector 136 may be reflected by a second mirror segment 128 to provide a second reflected beam 138, and a third scattered light sector 140 may be reflected by a third mirror segment 130 to provide a third reflected beam 142. In this manner, raster mirror 120 redirects light 112 into the objective element 122 to gather scattered light from the entire field of view 144 that can range from greater than 10° to about 180°.

As used in this disclosure, the term objective or phrase objective element can include either a refractive (lens) optical element or a reflective (mirror) optical element that receives light rays and forms an image. A lens may typically introduced chromatic aberrations. While an objective is typically the first element that receives light rays in an optical system, this is not considered essential since filters or other elements may be interposed prior to the objective in an optical path or optical train. Also, the term beam may include a plurality of light rays in a region and not be limited to a single ray. For example, light 112 may include a plurality of light rays that are generally oriented in a similar direction or towards a similar element and having a cross-sectional beam area. Detector element 124 may include a single charge-coupled device (CCD) imaging element, an array of CCD imaging elements, or an array of discrete transducers to convert the image beam information into an electrical signal that may be supplied to a signal processor for storage and/or analysis.

For a planar mirror segment raster mirror embodiment, each of the plurality of planar mirror segments has a normal angle extending perpendicular to the surface of each of the planar reflective elements, where the normal angle is articulated, tilted, angled, or slightly different, between adjacent mirror segments to provide reflection onto a different portion of detector element 124, which provides an image signal corresponding to the reflected signals. A suitably programmed signal processor may receive the image signal and determine one or more properties of the atmospheric aerosols to provide spectral, spatial, and temporal information about the atmospheric boundary layer.

The mirror segments (126, 128, 130) may be articulated or tilted relative to each other so that at least one of the reflections is aimed at a different location on detector element 124, or so that all reflections are aimed at different locations. Additionally, a neutral density (ND) filter may be placed in front of the mirror segments the dynamic range of the received signals. In this manner, detector element 124 may be better able to discriminate weaker signals from each portion of the reflected light beam 112, and permit the use of a lower power emitter 106. While three mirror segments (126, 128, 130) are shown, this is not considered limiting. Scattered light may be captured by receiver 104 from a field of view (FOV) angle 144 that can range from greater than 10° up to less than 180°. The upper limit angle is defined by the geometry due to the distance between the receiver and transmitter and the altitude of the receiver relative to the transmitter. In one exemplary ground-based placement, the transmitter and receiver may be placed about 158 meters apart.

The objective 122 can be reflective or refractive, and the reflected light beams (134, 138, 142) may be incident upon objective 122, which may either transmit or reflect the reflected light beams forming an image of the scattered light 112 on detector 124. When objective 122 is a refractive element, such as a lens, the reflected beams (134, 138, 142) pass through objective 122 and are then incident upon a portion of detector element 124. When objective 122 is a reflective element, such as a parabolic or an elliptical mirror, the reflected beams (134, 138, 142) do not pass through objective 122, and are instead reflected to provide a plurality of objective beams. A narrow band optical filter may be utilized when the measurements are performed during the daytime to reduce the solar background and increase the signal-to-noise (S/N) ratio.

A vertical field of view (FOV) of greater than 100° may be more suitable to image the scattered light from the ground level through the boundary layer at higher altitude. Hence, one or more embodiments of the present invention provide an innovative optical design to beneficially address one or more of the problems in existing CLidar systems. Specifically, one or more embodiments of the innovative CLidar system may provide at least two orders-of-magnitude increase in the light gathering power (étendu) which yields a better range resolution and/or allows the use of lower power, eye safe lasers. An increase in light gathering power of about 260-times has been observed with an embodiment of the innovative CLidar system. Different types of aerosols may also be conveniently measured by changing either the wavelength of the laser transmitter and/or the pass-band of a narrow band filter within the receiver. Further, an embodiment may resolve the incompatibility of the acceptance angles of the optical system and the narrow band interference filter, and/or may balance the dynamic range of the signals measured by the CCD in order to increase the efficiency of the CCD matrix. A ground-based, Bistatic Lidar system to measure light scattering in the atmospheric boundary layer that fulfills all of the above needs was developed and tested for proof-of-concept.

While one transmitter beam is shown, CLidar receiver 104 can be used for the simultaneous measurements of scattering from several laser beams of different wavelength to provide spectral, spatial, and temporal information about the atmospheric boundary layer. By employing an off-axis parabolic mirror as an objective, chromatic aberration can be eliminated. That is, this system can be used in a broad spectral range from infrared (IR) light, visible light, to ultraviolet (UV) light. In at least one embodiment, receiver 104 has the ability to control the dynamic range of the molecular signal registered by detector array 124 by including neutral density (ND) filters disposed adjacent to the incident side of individual sub-mirrors. A ND filter reduces or impedes the intensity of all wavelengths equally. Thus, the system may provide mutual correlation of adjacent CCD segments that allows the receiving of continuous data.

Bistatic Clidar system 100 may also include a control and signal processor 150 configured to receive image signals from detector 124 and provide control to one or more transmitters 102. Processor 150 may be a suitably programmed computer configured to fetch, decode, and execute computer instructions stored on a fixed or a selectively removable memory 156. Processor 150 may control the duration and timing of light transmission from one or more transmitters 102, and may also processes received image signals based on an image processing algorithm. In this manner, an embodiment of the present invention includes a method of measuring atmospheric properties based on computer instructions that may be stored on a computer readable medium.

While a conventional CLidar system typically provides a low light gathering power, embodiments of the present invention may provide two orders-of-magnitude improvement and up to 260 times improved light gathering power, allowing the use of eye-safe lasers in transmitter 102. While a conventional Clidar receiver may provide a spatial resolution that is greater than 500 mm at the ground level, receiver 104 may provide a spatial resolution that is better than 20 mm at the ground level. While a conventional CLidar may provide a field of view of 100° or less, a receiver according to an embodiment may provide a field of view that is greater than 100°. A conventional Clidar may require a receive signal with a higher dynamic range, while a receiver according to an embodiment may provide a controllable and/or use a lower dynamic range for the received signal.

In a traditional optical Lidar receiver, the acceptance angles of the optical objective and narrow band interference filters may not be compatible, thus requiring a much broader optical filter that leads to increased background solar radiation on the detector while significantly reducing the signal-to-noise (S/N) ratio. In contrast, a novel receiver may provide acceptance angles that are compatible with IR filters. Finally, while a traditional optical lidar receiver may provide an inefficient use of the CCD, a novel receiver may utilize a higher percentage of the detector area (up to the entire CCD area), while allowing simultaneous measurements at multiple spectral ranges to provide spectral, spatial, and temporal information about the atmosphere.

In contrast to embodiments of the present invention, a typical multi-lens conventional approach to the optical system design may allow only a very small effective area for partial angles of view for a single CCD pixel, thus reducing the light gathering power and requiring the use of a high power transmitter. More specifically, a convention approach typically includes a lower light gathering power, a spatial resolution of more than 500 mm, a field of view (FOV) of not more than 100°, along with the added cost of using a complex, multi-element objective. Further, the received signal for a traditional system must have a high dynamic range, calling for a high-power transmitter, and which may preclude the use of eye-safe lasers having lower power. Optical modeling and analyses have shown that a given wide field of view increases the difficulty in achieving sufficient étendu, or light gathering power, with standard multi-lens approaches, even using cylindrical optics. A complex, multi-element objective further leads to inefficient use of the detector array element (CCD), polarization losses at large incident angles, and results in a very small effective area for partial angles of view for a single CCD pixel.

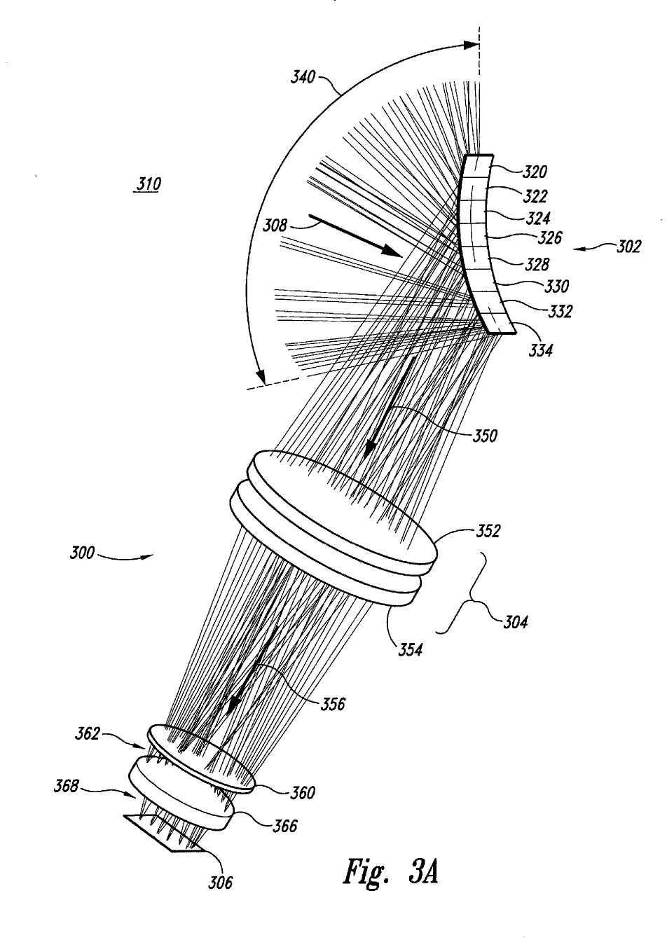

FIG. 2 illustrates a plan view of an exemplary detector element 124, in accordance with an embodiment of the present invention. Detector element 124 may be a two-dimensional (2-D) array of sensor elements, including a charge coupled device (CCD), such as the ST-8XME camera available from Santa Barbara Instruments Group of Santa Barbara, Calif., USA. The different reflected portions from the plurality of articulated planar mirror segments may be directed to different portions (202, 204, 206) of the detector element 124 array (i.e. different lines). In this manner, each portion of the field of view may be simultaneously and separately analyzed.

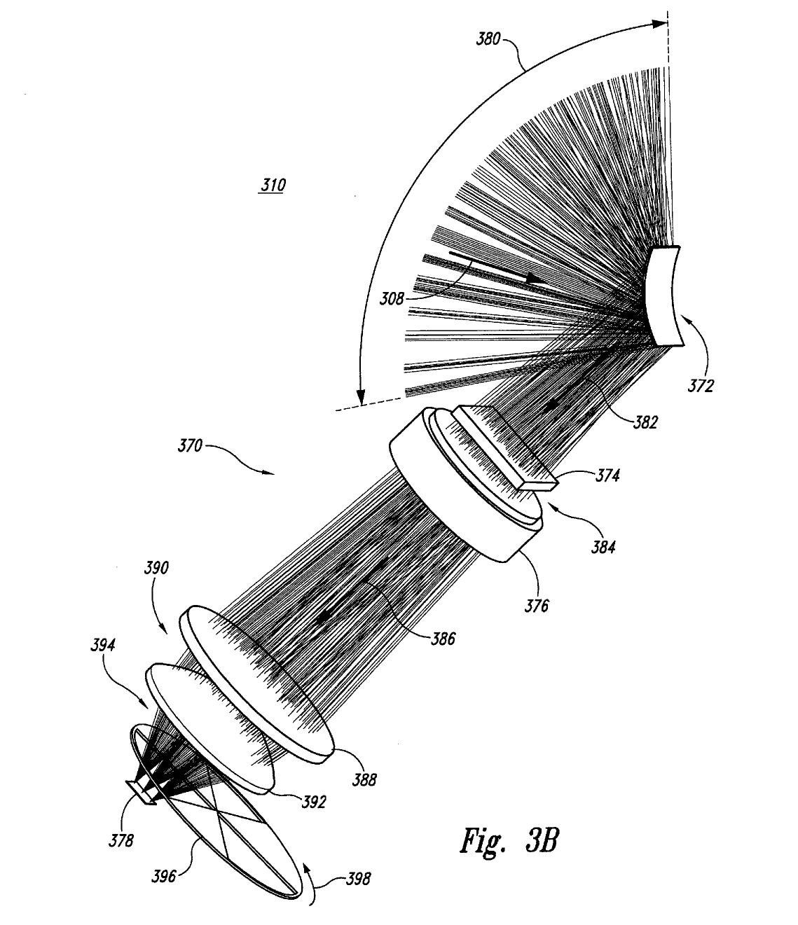

FIG. 3A illustrates a perspective view of a single-channel Clidar receiver 300 having a concave raster mirror 302 and a refractive objective 304, in accordance with an embodiment of the present invention. Receiver 300 may offer an angular resolution of about 0.005° across the entire field, and be applicable for day and night aerosol monitoring over a broad spectral range from UV to IR. Receiver 300 may include a single detector element 306, comprising a single-channel receiver. Incident light 308 from at least one laser transmitter and scattered by aerosols in the atmosphere 310 is incident upon concave raster mirror 302 that includes eight mirror segments (320, 322, 324, 326, 328, 330, 332, 334), where each mirror segment includes a planar mirror surface and may include an associated neutral density (ND) filter. Each mirror segment is articulated, or tilted, relative to its neighboring mirror segments. Mirror 302 is considered concave since the reflective portion of mirror 302 is curved inward as shown, like the inner surface of a sphere. Concave raster-mirror 302 divides the wide field of view 340 into eight sectors, redirecting the light into the objective element 304 common for all sectors to gather scattered light from the entire field of view 340 that can range from greater than 100 to about 120° for a given geometry of the receiver 300. Due to the linear nature of the light source, the size of the mirrors in the horizontal plane should be maximized to utilize the entire diameter of the objective element to provide maximum scattered light collection and, thereby, increase the sensitivity of the system, and allow the use of a lower power laser beam.

Incident light 308 is reflected by raster mirror 302 as reflected light 350 that is directed towards refractive objective 304, where refractive objective 304 may include one or a plurality of refractive elements (352, 354). As shown in FIG. 3A, refractive objective 304 may include a receiving lens 352 and a transmitting lens 354. Reflected light 350 is incident upon refractive objective 304 to produce an objective beam 356. A narrow band (NB) interference filter 360 receives the objective beam 356 and produces a filtered beam 362 that is applied to an imaging lens 366 that forms the image beam 368 that is applied to a two dimensional (2-D) sensor array of detector element 306. In this manner, filter 360 is located behind the objective in the optical path of the scattered light. The properties and relative placement of objective element 304 and imaging lens 366 define an effective focal length for the optics imaging the scattered light 308 onto detector element 306. A light blocking member (not shown), such as a “chopper”, may be interposed between imaging lens 366 and detector element 306 to selectively block light in order to reduce interference from solar background radiation during the observation period. For example, the chopper may be a slotted wheel rotating in synchronization with the image capture to selectively capture light from one or more transmitters 102, and to allow use of a continuous beam laser transmitter 102. Detector element 306 receives the applied image beam 368 and produces one or more corresponding image signals that may be analyzed by a signal processor to determine one or more properties of the atmospheric aerosols. Receiver 300 may detect scattered light from more than one laser beam simultaneously in order to determine some attributes of the scattering aerosols.

FIG. 3B illustrates a perspective view of another single-channel Clidar receiver 370 having a concave raster mirror 372, a NB interference filter 374, and a refractive objective 376, in accordance with an embodiment of the present invention. Receiver 370 is also adapted for day and night aerosol monitoring, and may include a single detector element 378. Incident light 308 from at least one laser transmitter and scattered by aerosols in the atmosphere 310 is incident upon concave raster mirror 372 that includes a ten mirror segments, where each mirror segment includes a planar mirror surface that is 5 mm by 40 mm in size, and may include an associated neutral density (ND) filter (not shown).

Each mirror segment is articulated or tilted relative to its neighboring mirror segments. Concave raster-mirror 372 divides the wide field of view 380 into a plurality of sectors, reflecting light 308 as a reflected light beam 382 that is directed to filter 374 that emerges as a filtered beam 384 that is applied to objective element 376. In this manner, filter 374 is located before objective element 376. An exemplary filter 374 may have a 1 nm (nanometer) pass band at 532.4 nm central wavelength, and is available from Andover Corporation of Salem, N.H., USA. Field of view 380 can range from greater than about 10° to about 120°, and is preferably greater than about 15° and less than about 120° for the given geometry. Due to the linear nature of the light sources, the size of the mirrors in the horizontal plane should exceed the diameter of the objective element to provide maximum scattered light collection and, thereby, increase the sensitivity of the system, and allowing the use of a lower power laser beam.

Filtered beam 384 that is applied to objective element 376 emerges as an objective beam 386 that is incident upon a second lens 388 that transmits a beam 390 that is applied to an imaging lens 392 that forms an image beam 394 that is applied to a two dimensional (2-D) sensor array of detector element 378. The properties and relative placement of objective element 376, lens 388, and imaging lens 392 define an effective focal length for the optics imaging the scattered light 308 onto detector element 378. A light blocking member 396, such as a “chopper”, may be interposed between imaging lens 392 and detector element 378 to selectively block light in order to reduce interference from solar background radiation during the observation period or to allow use of a continuous beam laser transmitter 102, as described above. In one embodiment, chopper 396 is a slotted wheel rotating in a first direction 398 in synchronization with the image capture from detector 378 to eliminate background radiation, to selectively capture light from one or more transmitters 102, and/or to allow use of a continuous beam laser transmitter 102.

Various exemplary embodiments of the novel Clidar receiver were modeled and analyzed using an optical design software package ZEMAX (R) provided by ZEMAX Development Corporation of Bellevue, Wash., USA. Several refractive objective embodiments similar to the disclosed embodiments were modeled and analyzed, and performance summaries are included herein. Other arrangements of mirror configurations, mirror segment sizes, and focal length are possible.

In reference to FIG. 3A, a first modeled refractive embodiment includes an effective focal length of 150 mm (elements 304, 366) and a concave raster mirror 302 having eight mirror segments, where each mirror segment is 26 mm wide by 10 mm high. The analytically determined altitude resolution for the first refractive embodiment is 18 mm/pixel (millimeters/pixel) at ground level and 175 mm/pixel at 20 km altitude.

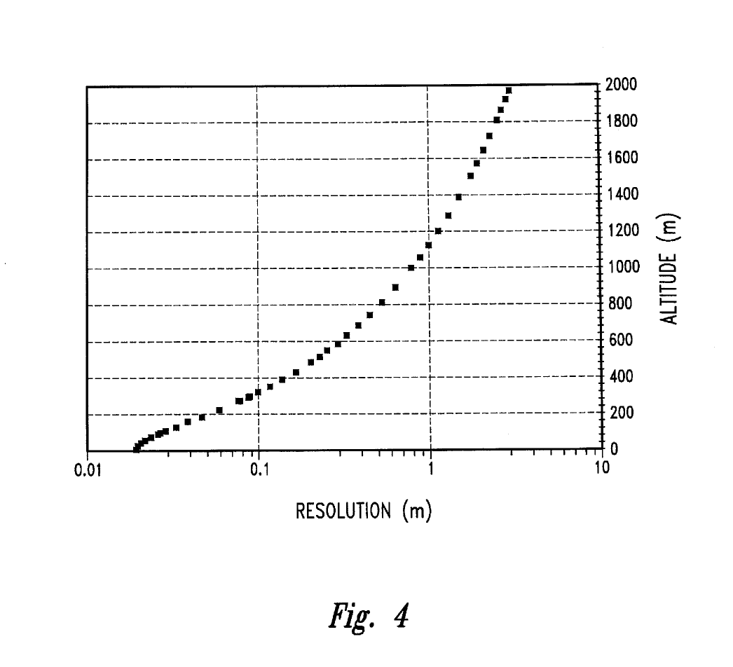

In reference to FIG. 3B, a modeled refractive embodiment includes a concave raster mirror having ten mirror segments, where each mirror segment is 40 mm wide by 5 mm high. As shown, the interference filter is disposed in front of the objective in the optical path of the scattered light. This modeled embodiment includes a detector with a pixel size of 9×9 microns and an effective focal length of 70 mm corresponding to the dimensions of the detector. The analytically determined altitude resolution for this refractive embodiment is 20 mm/pixel at ground level and 3.1 m/pixel at 20 km altitude. FIG. 4 is a graph illustrating the analytical performance of this modeled refractive embodiment.

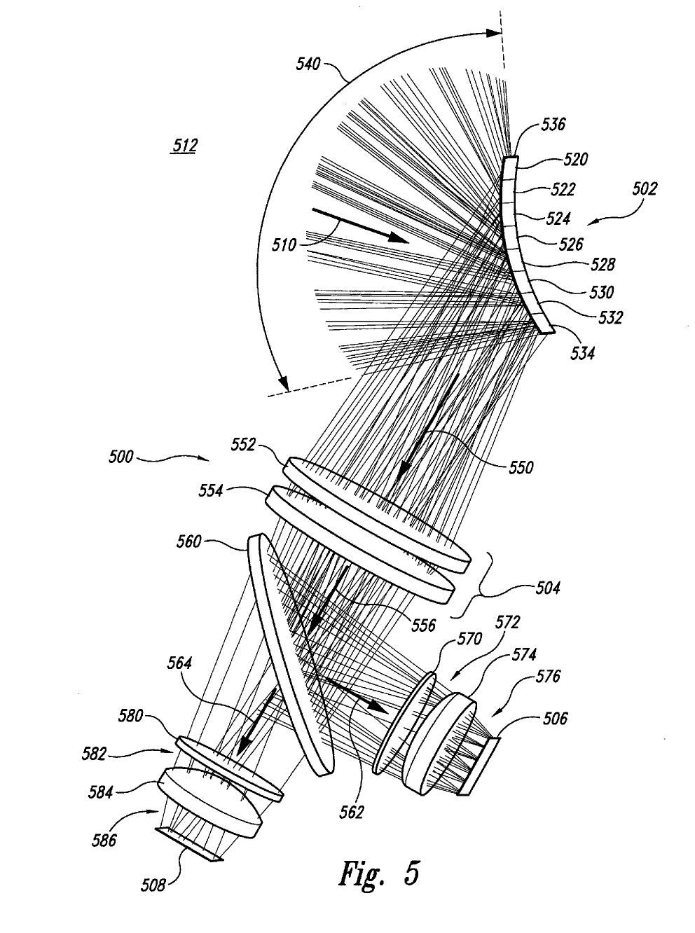

FIG. 5 illustrates a perspective view of a dual-channel Clidar receiver 500 having a concave raster-mirror 502, a refractive objective 504, and two detector elements (506, 508), in accordance with an embodiment of the present invention. As exemplified by the embodiment of FIG. 5, each disclosed single channel receiver may be converted into an analogous dual-channel receiver. The embodiment of FIG. 5 may be used to detect aerosol properties, in daytime or nighttime conditions, by simultaneously receiving scattered light from multiple transmitters at different wavelengths over a broad spectral range from UV (Ultraviolet) to near infrared (NIR). The exemplary system 500 implements two CCD cameras, where the quantum efficiencies of each camera are centered about the working wavelength of the corresponding transmitter.

Incident light 510 from at least two laser transmitters and scattered by aerosols in the atmosphere 512 is incident upon concave raster mirror 502 that includes eight mirror segments (520, 522, 524, 526, 528, 530, 532, 534), where each mirror segment includes a planar mirror surface 536 and is articulated relative to its neighboring mirror segments. Concave raster-mirror 502 divides the wide field of view 540 into eight sectors, redirecting the light into the objective element 504 common for all sectors to gather scattered light from the entire field of view 540 that can range up to about 120°. Due to the linear nature of the light sources, the size of the mirrors in the horizontal plane should exceed the diameter of the objective element to provide maximum scattered light collection and, thereby, increase the sensitivity of the system, and allowing the use of a lower power laser beam.

Incident light 510 is reflected by raster mirror 502 as reflected light 550 that is directed towards refractive objective 504, where refractive objective 504 may include one or a plurality of refractive elements (552, 554). As shown in FIG. 5, refractive objective 504 may include a receiving lens 552 and a transmitting lens 554. Reflected light 550 is incident upon refractive objective 504 to produce an objective beam 556.

Objective beam 556 may be applied to beam splitting element 560, such as a dichroic filter, to produce a reflected objective beam 562 and a transmitted objective beam 564. Dichroic filter 560 may have particular properties to reflect a first wavelength or band of wavelengths, while transmitting other wavelengths outside of the reflected band. An exemplary dichroic filter 560 is serial number NT47-267 supplied by Edmund Optics of Barrington, N.J., USA.

A first narrow band (NB) interference filter 570 receives the reflected objective beam 562 and produces a first filtered beam 572 that is applied to a first imaging lens 574 that produces a first image beam 576 that is applied to a first two dimensional (2-D) sensor array of first detector element 506. The properties and relative placement of objective element 504 and an imaging lens 574 define a first effective focal length for imaging the scattered light 510 onto first detector element 506. First detector element 506 receives the applied image beam 576 and produces corresponding image signals that may be analyzed by a signal processor to determine one or more properties of the atmospheric aerosols.

Similarly, a second narrow band (NB) interference filter 580 receives the transmitted objective beam 564 and produces a second filtered beam 582 that is applied to an imaging lens 584 that produces a second image beam 586 that is applied to a second two dimensional (2-D) sensor array of first detector element 508. The properties and relative placement of objective element 504 and imaging lens 584 define a second effective focal length for imaging the scattered light 510 onto second detector element 508. Second detector element 508 receives the applied image beam 586 and produces corresponding image signals that may be analyzed by a signal processor to determine one or more properties of the atmospheric aerosols.

First detector 506 and first filter 570 and imaging lens 574 may be configured to detect a particular wavelength or band of scattered light from a particular laser transmitter while second detector 508, second filter 580, and imaging lens 584 may be configured to detect another wavelength or band different from the first band so that scattered light from a plurality of light sources may be simultaneously analyzed to determine various atmospheric aerosol properties. Specifically, the dimensional properties and density of the atmospheric aerosols may be determined using simultaneous detection from two light sources. By using a UV laser transmitter, the luminescence and the Raman spectrum of an atmospheric species can be measured, thus determining the density and the composition profile of the atmosphere through the boundary layer. In one embodiment, filter 570 may have the properties of reflecting radiation at 473 nm to detect scattered laser light at the wavelength of an emitting transmitter 473 nm (nanometers), while filter 580 may have the properties of transmitting radiation at the wavelength of a second emitting transmitter 532 nm, so that a simultaneous measurement of scattered radiation at dual wavelengths may be performed.

In reference to FIG. 5, a modeled dual-channel refractive embodiment includes an effective focal length of 150 mm and a concave raster mirror having eight mirror segments, where each mirror segment is 26 mm wide by 10 mm high. The analytically determined altitude resolution for this refractive embodiment is 18 mm/pixel at ground level and 175 mm/pixel at 20 km altitude.

Again in reference to FIG. 5, another modeled refractive embodiment includes an effective focal length of 150 mm and a concave raster mirror having eight mirror segments, where each mirror segment is 20 mm wide by 6 mm high. The analytically determined altitude resolution for this refractive embodiment is 18 mm/pixel at ground level and 175 mm/pixel at 20 km altitude.

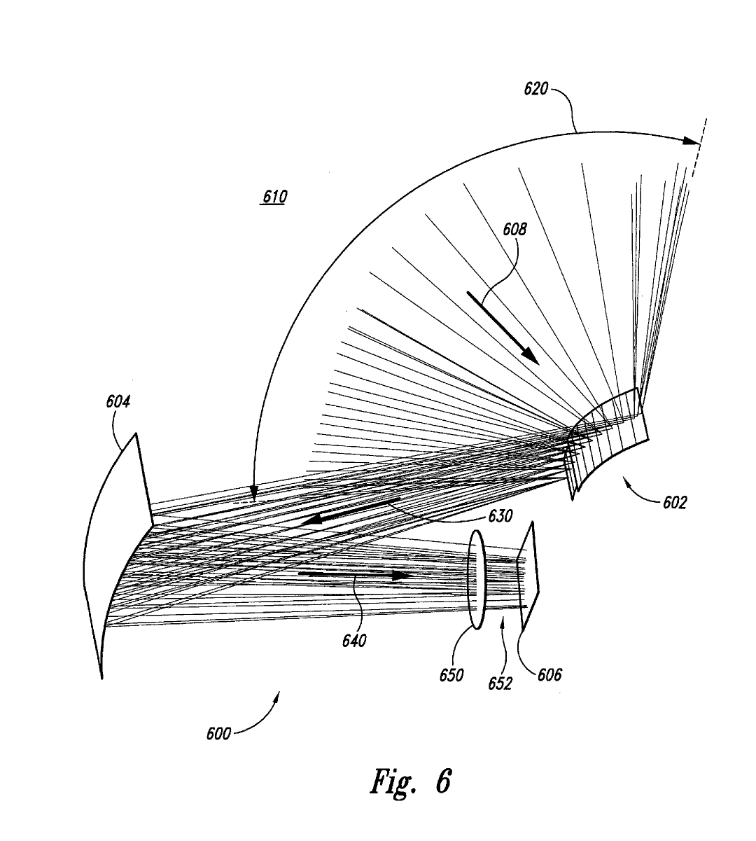

FIG. 6 illustrates a perspective view of a single-channel Clidar receiver 600 having a concave raster-mirror 602 and a reflective objective 604, in accordance with an embodiment of the present invention. Receiver 600 may offer an angular resolution of about 0.105° on across the entire field, and is adapted for day and night aerosol monitoring over a broad spectral range from infrared (IR) to ultraviolet (UV). Incident light 608 from at least one laser transmitter and scattered by aerosols in the atmosphere 610 is incident upon concave raster mirror 602 that includes a plurality of mirror segments, where each mirror segment includes a planar mirror surface that is articulated relative to its neighboring mirror segments. Concave raster-mirror 602 divides the wide field of view 620 into a plurality of sectors, redirecting the light into the objective element 604 common for all sectors to gather scattered light from the entire field of view 620 that can range up to about 120°, depending on the geometry of the receiver and the transmitter relatively to each other and the altitude of the receiver relative to the transmitter.

Incident light 608 is reflected by raster mirror 602 as reflected light 630 that is directed towards reflective objective 604, where reflective objective 604 may comprise an off axis parabolic mirror. Reflected light 630 is incident upon reflective objective 604 to produce an objective beam 640. A narrow band (NB) interference filter 650 receives the objective beam 640 and produces a filtered beam 652 that is applied to a two dimensional (2-D) sensor array of detector element 606. Alternatively, an additional imaging reflector element may be used to produce an image beam that is applied to detector 606. An additional imaging element is not required in this case if the off-axis parabolic mirror, reflective objective element 604, is properly placed to have the right focal length. The dimensions of the detector 606 and relative placement of objective element 604 and its focal length define an effective focal length for imaging the scattered light 608 onto detector element 606. As in the other embodiments, NB filter 650 can be replaced by a NB filter having a different spectral pass band without refocusing the optical system, thus allowing the spectral broadband imaging and measurement of the scattered aerosols. Detector element 606 receives the applied filtered beam 652 and produces corresponding image signals that may be analyzed by a signal processor to determine one or more properties of the aerosols in atmosphere 610.

In one embodiment, reflective objective 604 is an off axis parabola and has a 150 mm focal length to provide the resolution of 0.3 m/20 pixels near the ground, and degrading to 2.6 km/12 pixels at 20 km. Detector 606 may be implemented as an ultraviolet (UV) enhanced, back-illuminated full-frame 4-megapixel CCD sensor array, such as the Alta E42 (R) available from Apogee Instruments of Logan, Utah, USA. Concave raster-mirror 602 includes 10 sub-mirrors that are 20 mm by 6 mm each. This achromatic reflective optical system may be used with multiple laser transmitters and is tuned to match the Apogee E42 detector described above. The optical train of this exemplary embodiment has compatible acceptance angles in reference to the narrow band interference filter, which allows the optional placement of another filter at the incident side of objective 604 to eliminate chromatic aberration.

Similar to the embodiment shown in FIG. 6, two exemplary reflective embodiments were modeled and analyzed, and summaries of the analyzed performance are described as follows. A first modeled reflective embodiment includes a focal length of 50 mm (millimeters) and a concave raster mirror having ten mirror segments, where each mirror segment is 20 mm wide by 6 mm high. The analytically determined altitude resolution for the first reflective embodiment is 0.5 m/pixel (meters/pixel) at ground level and 10 km/pixel (kilometers/pixel) at 20 km altitude. A second modeled reflective embodiment includes a focal length of 150 mm and a concave raster mirror having ten mirror segments, where each mirror segment is 20 mm wide by 6 mm high. The analytically determined altitude resolution for the second reflective embodiment is 0.3 m/pixel at ground level and 2.6 km/pixel at 20 km altitude.

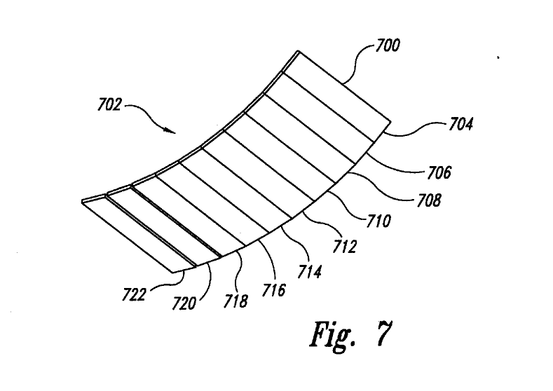

FIG. 7 illustrates a perspective view of an exemplary concave raster-mirror 700, in accordance with an embodiment of the present invention. Concave raster-mirror 700 has a piece-wise planar reflective surface 702 that includes a plurality of mirror elements 704-722, where each mirror element is articulated relative to its adjoining mirror elements.

Any combination of the disclosed elements may be used to construct a detection apparatus and/or system within the scope of the present invention. A ground based system that incorporates an embodiment of the disclosed CLidar receiver can be very beneficial for monitoring boundary layer aerosols. Applications also include assessing the impact of anthropogenic and natural aerosols on climate, measuring the air quality and health effects, and studying the variability of aerosol profiles for dynamics studies. The high resolution of the data which extends all the way to the ground has distinct advantages over the standard lidar methods such as Micropulse lidar (MPL). The very large improvement in light gathering of the design may make it possible to use the technique to monitor water vapor, tropospheric ozone, and other trace gases. The monitoring of trace gases would have industrial and commercial applications. A network of ground-based CLidar receivers, based on the various embodiments may also be used.

Embodiments described above illustrate but do not limit the invention. It should also be understood that numerous modifications and variations are possible in accordance with the principles of the present invention. Accordingly, the scope of the invention is defined only by the following claims.

We claim:

1. An optical measurement apparatus, comprising:
a raster-mirror having a plurality of mirror segments, each mirror segment being articulated relative to an adjacent mirror segment and configured to receive light from a portion of a field of view and provide a reflected light portion, the plurality of reflected light portions comprising a reflected beam;
an objective element configured to receive the reflected beam and provide an objective beam having a plurality of objective beam portions corresponding to the plurality of reflected light portions; and
a detector element comprising a plurality of detector portions and configured to receive the objective beam and provide a corresponding image signal, the plurality of objective beam portions being simultaneously imaged on the plurality of different detector portions.

2. The apparatus of claim 1, wherein the plurality of mirror segments are one of planar and non-planner, the plurality of mirror segments being arranged in one of a concave and a convex manner.

3. The apparatus of claim 1, further comprising a first filter element disposed between the raster mirror and the objective element and configured to receive the reflected beam and provide a first filtered beam to the objective element, the objective element being configured to receive the first filtered beam and provide the objective beam.

4. The apparatus of claim 3, wherein the first filter element is a narrow band filter.

5. The apparatus of claim 1, further comprising a second filter element disposed between the objective element and the detector element and configured to receive the objective beam and provide a second filtered beam to the detector element, the detector element being configured to receive the second filtered beam and provide the image signal.

6. The apparatus of claim 5, wherein the second filter element is a narrow band filter.

7. The apparatus of claim 1, further comprising a light blocking member disposed between the objective element and the detector element and configured to selectively block light.

8. The apparatus of claim 7, wherein the light blocking member includes a slotted wheel member configured to rotate, the rotation of the slotted wheel being configured to alternately pass and block light.

9. The apparatus of claim 1, wherein the received light is scattered by atmospheric aerosols.

10. The apparatus of claim 9, wherein at least one of spectral, spatial, and temporal information about the atmospheric aerosols is determined based on the image signal.

11. The apparatus of claim 1, wherein an entirety of the field of view being described by a field of view angle, the field of view angle being from about 10° to about 180°.

12. The apparatus of claim 11, wherein the vertical field of view angle is from about 10° to about 120°.

13. The apparatus of claim 1, wherein the objective element is one of a refractive element and a reflective element.

14. The apparatus of claim 13, wherein the reflective objective element is an off-axis parabolic mirror.

15. The apparatus of claim 1, wherein the detector element includes a charge-coupled device (CCD) array.

16. The apparatus of claim 1, wherein the apparatus has a resolution of about 20 mm/pixel when measuring scattered light from a ground level position.

17. The apparatus of claim 1, wherein the apparatus has a resolution of about 3 m/pixel when measuring scattered light from a 20 kilometer position above a ground level position.

18. The apparatus of claim 1, further comprising:
a processor configured to execute computer instructions, the processor being configured to receive the image signal and provide a measurement of at least one atmospheric property.

19. The apparatus of claim 1, further comprising:
a laser transmitter configured to emit laser light within at least one of an infrared, a visible, and an ultraviolet range, the emitted laser light being scattered by atmospheric aerosols and incident upon the raster-mirror.

20. The apparatus of claim 1, further comprising:
a beam splitting element disposed between the objective element and the detector element, the beam splitting element being configured to receive the objective beam and provide a reflected objective beam and a transmitted objective beam, the detector element being a first detector element and being configured to receive the transmitted objective beam and provide a first image signal;
a second detector element disposed adjacent to the beam splitting element and configured to receive the reflected object beam and provide a second image signal; and
a second filter element disposed between the beam splitter element and the second detector element,
wherein the first and second image signals are based on receiving scattered laser light from two different laser transmitters.

21. A method, comprising:
receiving light scattered from atmospheric aerosols;
reflecting the received scattered light using a raster-mirror having a plurality of mirror segments, each mirror segment being articulated relative to an adjacent mirror segment and configured to receive light from a portion of a field of view and provide a reflected light portion;
imaging the plurality of reflected light portions simultaneously on different portions of a detector element to provide an image signal; and
measuring at least one of a spectral, a spatial, and a temporal property about the atmospheric aerosols based on the image signal.

22. The method of claim 21,
wherein the light scattered by the atmospheric aerosols is emitted by a laser transmitter,
wherein the measurement a resolution of about 20 mm/pixel when measuring scattered light from a ground level position, and
wherein the measurement has a resolution of about 3 m/pixel when measuring scattered light from a 20 kilometer position above a ground level position.

23. A computer readable medium on which is stored a computer program for executing the following instructions:
receiving light scattered from atmospheric aerosols;
reflecting the received scattered light using a raster-mirror having a plurality of mirror segments, each mirror segment being articulated relative to an adjacent mirror segment and configured to receive light from a portion of a field of view and provide a reflected light portion;
imaging the plurality of reflected light portions simultaneously on different portions of a detector element to provide an image signal; and
measuring at least one of a spectral, a spatial, and a temporal property about the atmospheric aerosols based on the image signal.
